(19) United States
(12) Patent Application Publication
(10) Pub. No.: US 2004/0205923 A1
(43) Pub. Date: Oct. 21, 2004

(54) Wiper mechanism

(76) Inventors: Kevin Erik Hultquist, Bartlett, IL (US); Michael W. Parmelee, Naperville, IL (US)

Correspondence Address: BIRCH STEWART KOLASCH & BIRCH, PO BOX 747, FALLS CHURCH, VA, 22040-0747, US

(21) Appl. No.: 10/824,397

(22) Filed: Apr. 15, 2004

Related U.S. Application Data
(60) Provisional application No. 60/463,731, filed on Apr. 18, 2003.

(51) Int. Cl. B60S 1/24; B60S 1/18; B60S 1/34

(52) U.S. Cl. 15/250.31; 15/250.3; 15/250.34

(57) ABSTRACT

A drive mechanism 10 for a windshield wiper has a pivot 11 with a first end with an internally threaded hole 22 for receiving a screw 23 for securing a wiper arm. The first end has a coupling surface 24 adapted to mate with a DIN style wiper arm attachment. A ring driver 25 is fitted to the end of the pivot and mates with the coupling surface 24. The driver has an outer surface 27 adapted to mate with a US style wiper arm attachment.

### FIELD AND BACKGROUND OF THE INVENTION

This invention relates to windshield wipers and in particular, to a wiper mechanism for use in a single wiper unit.

Windshield wiper mechanisms can generally be classed as DIN style or US style. The difference relates to the attachment of the wiper arm to the wiper mechanism or wiper pivot. In the DIN style system, the wiper arm is mated with a tapered and knurled portion of a shaft forming the wiper pivot and is locked in place by a nut threaded to an end of the shaft which passes through a tapered socket of the wiper arm, clamping the arm to the shaft. In the US style system, a tapered and knurled ring driver is fitted and keyed to the shaft of the wiper pivot by way of two tapered flat edges. A tapered socket of the wiper arm is mated with the ring driver and locked in place by a nut threaded onto the end of the shaft. As the US style driver is physically larger than the DIN style connector, the DIN style and US style wiper arms are not interchangeable. A disadvantage of this for the manufacturer is that wiper mechanisms for the US and DIN markets are not interchangeable requiring separate models to supply the different markets.

Thus, there is a need for a single wiper mechanism which can be used for both DIN and US style markets.

### SUMMARY OF THE INVENTION

Accordingly, the present invention provides A windshield wiper mechanism for driving a windshield wiper comprising: a mounting bracket; a motor fixed to the bracket; a crank driven by the motor; a pivot for pivotably driving a windshield wiper arm; the pivot being pivotably connected to the bracket by a bearing; the pivot has a first end and a second end; the first end having a DIN style tapered and knurled coupling surface; a ring driver, having a through hole with an inner surface adapted to mate with the coupling surface of the pivot arm and a tapered and knurled outer surface adapted to mate with a US style socket of a windshield wiper arm; fastening means for securing the driver and the wiper arm to the first end of the pivot; a pivot lever fitted to the second end of the pivot arm; and a connecting link pivotably connected to the crank and the pivot lever for transforming rotary motion of the crank to oscillatory motion of the pivot through a predetermined angular extent.

Optional and preferred features of the invention are set forth in the dependent claims.

### BRIEF DESCRIPTION OF THE DRAWINGS

One preferred embodiment of the invention will now be described, by way of example only, with reference to the single figure of the accompanying drawing in which:

FIG. 1 is a partially exploded perspective view of a drive mechanism for a windshield wiper according to the preferred embodiment of the present invention.

### DETAILED DESCRIPTION OF THE PREFERRED EMBODIMENTS

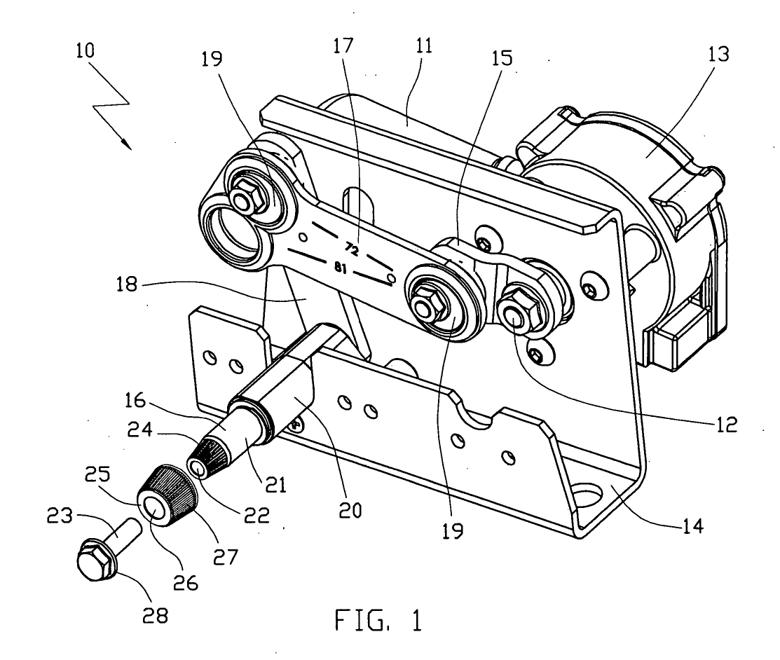

FIG. 1 shows a drive mechanism 10 for a windshield wiper. The drive mechanism provides an oscillating pivot for driving or moving a wiper arm through a predetermined angular range for wiping a windshield. This mechanism has a single driving pivot for moving a single wiper arm and therefore, is particularly suited for use in trucks and buses or other large vehicles with independent wipers or for use with rear windows.

The drive mechanism 10 comprises an electric motor 11 driving an output shaft 12 through a gearbox 13. The motor 11 and gearbox 13 are mounted on the back of a U-shaped mounting bracket 14. An offset lever or crank 15 is fixed to the output shaft for rotation therewith. The crank 15 drives a pivot 16 in an oscillating motion through a connecting link 17 and a lever 18. The dimensions of the crank 15, link 17 and lever 18 determine the angular oscillations of the pivot 16. The connecting link 17 is pivotably connected to the crank 16 and lever 18 by drivers 19. The lever 18 is fixed to the pivot 16 for rotational movement therewith. The pivot 16 is supported by a bearing 20 which is mounted to the U-shaped bracket 14 which is used to mount the wiper mechanism to a vehicle for use therewith.

The pivot 16 has a distal end 21 remote from the lever 18 to which the wiper arm is connected. The distal end 21 of the pivot has an internally threaded axial hole 22 for receiving a screw 23 for fixing the wiper arm thereto. The outer surface of the distal end 21 has a tapered knurled portion 24 forming a coupling surface dimensioned to mate with a DIN style mounting socket of a wiper arm.

A ring driver 25 is provided to connect the pivot to a US style mounting socket of a wiper arm. The driver 25 has a through hole 26 with a tapered knurled inner surface (not shown) arranged to mate with the DIN style tapered knurled portion 24 of the pivot 16. The outer surface 27 of the driver 25 is tapered and knurled according to US style wiper requirements.

In use, the driver 25 is placed on the tapered portion 24 of the pivot 16 with the knurls meshed. A wiper arm with a US style mounting socket is placed onto the driver and the screw 23 placed through a hole in the wiper arm mount and the driver hole 26 and threadedly engages the hole 22 in the pivot 16. The screw 23 is tightened so that a flange 28 on the head of the screw bears down on the wiper arm mount and maintains the wiper arm fixedly secured to the pivot via the driver. Wiper arms with DIN style mounting sockets are fitted in a similar way directly to the tapered knurled portion 24 of the pivot 16 without the use of the driver 25.

Use of the ring driver negates the need to manufacture and maintain wiper mechanisms with both DIN style and US style pivots, thereby reducing inventory.

The embodiment described above is given by way of example only and various modifications will be apparent to persons skilled in the art without departing from the scope of the invention as defined in the appended claims.

For example, the internally threaded hole in the pivot and the screw could be replaced by a threaded shaft extension and a nut.

1. A windshield wiper mechanism for driving a windshield wiper comprising:
a mounting bracket;
a motor fixed to the bracket;
a crank driven by the motor;
a pivot for pivotably driving a windshield wiper arm, the pivot being pivotably connected to the bracket by a bearing, and having a first end and a second end, the first end having a DIN style tapered and knurled coupling surface;
a ring driver, having a through hole with an inner surface adapted to mate with the coupling surface of the pivot and a tapered and knurled outer surface adapted to mate with a US style socket of a windshield wiper arm;
fastening means for securing the driver and the wiper arm to the first end of the pivot;
a pivot lever fitted to the second end of the pivot; and
a connecting link pivotably connected to the crank and the pivot lever for transforming rotary motion of the crank to oscillatory motion of the pivot through a predetermined angular extent.

2. The wiper mechanism of claim 1 wherein the crank is driven by the motor through a gearbox.

3. The wiper mechanism of claim 1 wherein the fastening means comprises an internally threaded axial hole in the first end of the pivot and a screw to nip the wiper arm and driver to the pivot.
